(19) United States
(12) Patent Application Publication
(10) Pub. No.: US 2009/0100158 A1
(43) Pub. Date: Apr. 16, 2009

(54) Backup and Recovery System for Multiple Device Environment

(75) Inventors: Dmitry Sonkin, Redmond, WA (US); Unmesh Vartak, Sammamish, WA (US); Edward K Tremblay, Bellevue, WA (US); Christer Lundin, Bellevue, WA (US); Paul Fitzgerald, Woodinville, WA (US); Israel Hilerio, Kenmore, WA (US); Bruce Johnson, Woodinville, WA (US); Aaron Colling, Seattle, WA (US); Rong Cao, Redmond, WA (US); Krishna Sunkammurali, Sammamish, WA (US); Murali Vajjiravel, Sammamish, WA (US); Ozan Eren Bilgen, Bellevue, WA (US); Alireza Farhangi, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/871,171

(22) Filed: Oct. 12, 2007

(51) Int. Cl. G06F 15/177

(52) U.S. Cl. 709/221; 709/220

(57) ABSTRACT

A backup system stores configuration data for several interdependent systems in a single backup store. As the systems are being configured and when changes are made to the systems, the backup store is updated with the change. The systems may be configured with each system having a designated role. During a restore operation, an otherwise unallocated system may assume a particular role and use the configuration logic defined for the role that may be taken from the backup store. The system may perform the restore in conjunction with the other systems and the interdependencies with the systems.

### BACKGROUND

Backup and restore operations for multiple server or devices that depend on other devices can be a very complex operation. As a system is being restored, each step may depend on a service or function that may be provided by another system. In many cases, a restore operation may not be able to continue until the service on which it depends is properly functioning. When multiple interdependencies exist, or when two or more systems are being restored in a multi-system environment, an administrator often rebuilds the systems manually and slowly.

### SUMMARY

A backup system stores configuration data for several interdependent systems in a single backup store. As the systems are being configured and when changes are made to the systems, the backup store is updated with the change. The systems may be configured with each system having a designated role. During a restore operation, an otherwise unallocated system may assume a particular role and use the configuration logic defined for the role that may be taken from the backup store. The system may perform the restore in conjunction with the other systems and the interdependencies with the systems.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a centralized configuration data store.

FIG. 2 is a flowchart illustration of an embodiment showing a method for configuring a system using a centralized configuration data store.

FIG. 3 is a timeline illustration of an embodiment showing a sequence for detecting and storing configuration changes and for restoring a device.

### DETAILED DESCRIPTION

A centralized configuration store is used in a multiple device environment to track configurations of each device. Each change to one of the managed devices may be tracked in the configuration store with enough detail that one of the managed devices may be restored to the latest configuration or the various devices may be rolled back to a previous configuration.

A centralized configuration store may be used in an environment where devices may have interdependencies on each other. For example, some networked server applications operating on a first server may depend on a second server that provides various services, such as Domain Name Services (DNS). The first server may depend on the second server being properly functioning before the first server may proceed with installation and configuration. In many cases, the interdependencies may cause an installation sequence or restore sequence to progress to a certain point, wait for another device to progress to a certain point, then continue with the first sequence. In some cases, installation sequences or restore sequences may have many such interdependencies.

The centralized configuration store may store the configuration information for each device so that a device may be upgraded, replaced, or migrated easily. When an individual device is replaced, for example, the configuration information for the previous device may be extracted from the centralized configuration store and used to install and configure the various settings, functions, applications, and services on the new device.

Some services on each device may have an automated update mechanism that may send updates to the centralized configuration store each time a change is made. In some cases, multiple services may be installed and managed using a centralized control interface which may communicate changes to the centralized configuration store.

In some embodiments, some applications, services, functions, or settings may be detected by a monitoring system, which may detect and store configuration changes in the configuration store.

Many of the functions described for managing the configuration of a system may be performed through a change management tool. The configuration management tool may consolidate many functions relating to configuration, such as setting up a server or device, configuring services, monitoring status, storing a configuration, and restoring a server or device to a previous configuration. Such a tool may be used across multiple servers or devices in some embodiments to monitor and control several servers or devices.

The centralized configuration store referred to in this specification may include any type of storage mechanism. In many embodiments, a configuration store may be a distributed storage mechanism or directory service where files and data may be stored in two or more physical locations such as on separate servers.

Throughout this specification and claims, references to ‘services’ may include any function that may be configured to operate on a network connected device. Such functions may include operating system functions, application functions, services that interact across a network, or any other configurable function. Unless otherwise specifically mentioned, the terms ‘services’, ‘application’, ‘function’, or similar terms may be considered synonymous. The ‘services’ may be configured in any manner, including defining the scope of functions that may be performed, parameters that may be used by various functions, settings that may define behavior characteristics of functions, configuration parameters used to communicate with users or other devices, or any other configurable or changeable parameter relating to a service. The configuration settings may take the form of registry settings, configuration files, directory structures, or any other mechanism that may be used to change the behavior or other characteristics of a service.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

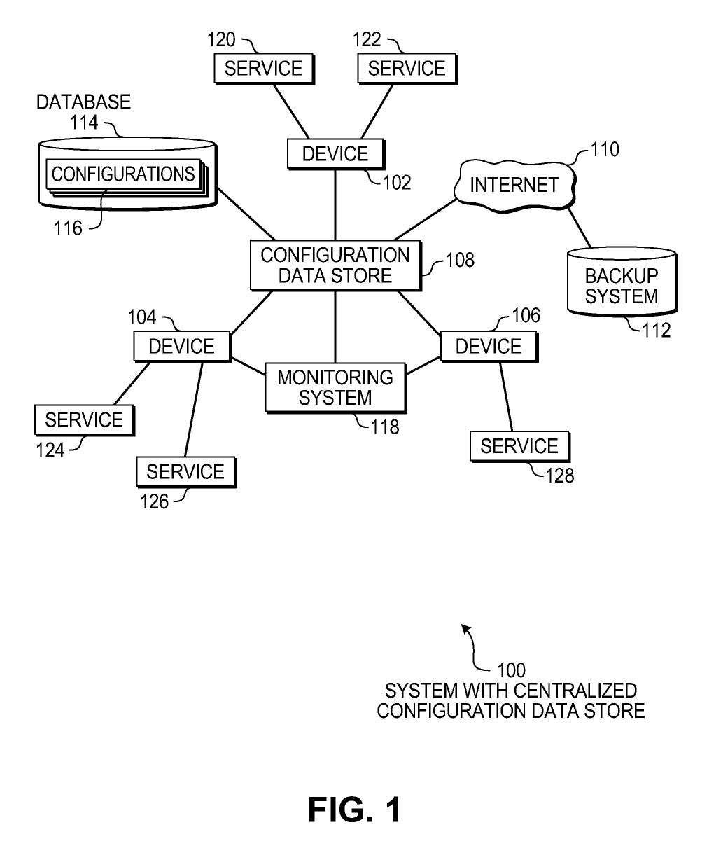

FIG. 1 is a diagram of an embodiment 100 showing a system with a centralized configuration store. Embodiment 100 is an example of a system that may have a configuration store that may be used for backing up and restoring a group of devices to specific configurations.

The diagram of FIG. 1 illustrates functional components of a system and may not correspond directly with a hardware or software component of a system. In some cases, a component may be a hardware component, a software component, or a combination of hardware and software. Hardware components may include general purpose components adaptable to perform many different tasks or specially designed components that may be optimized to perform a very specific function. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the various functions described.

Embodiment 100 shows devices 102, 104, and 106 connected to a configuration data store 108. The configuration data store 108 may collect configuration data from each of the devices and services operating on the devices for rolling back a configuration change, deploying a new system, migrating one system to a new hardware platform, replacing one of the devices, or other activities.

The configuration data store 108 may collect various configuration parameters in a database 114 that may have multiple configuration sets 116. Each configuration set may correspond with a restore point and may configuration parameters for each device and service operating on the device.

The configuration data store 108 may be connected to the Internet 110 where and offsite backup system 112 may keep a copy of the database 114.

Each device may have multiple services that interact with services provided on other devices. For example, device 102 may have services 120 and 122 that may provide network connectivity services that are used by services 124 and 126 on device 104. Services 124 and 126 on device 104 may not be able to properly function unless services 120 and 122 are operating. Similarly, device 106 may have service 128 that is dependent on services provided on either or both devices 102 and 104.

An example of such a system may be a multiple server environment that may be found in a small business. In such an example, one server may perform network connectivity, firewall, and web hosting, a second server may host email services and messaging services, while a third server may host a file management system. The third server with the file management system may depend on the network services from the first server, while the first server may depend on the file management system for the web services it provides.

In such an example, the various devices may host services that depend on services provided on another device. In many cases, installing and configuring each device is a multiple step setup process, where one service may be configured and started on a first device before a second service on a second device may be configured.

The configuration data store 108 may store the configuration information for each device 102, 104, and 106 in a centralized location and may keep track of the interdependencies between various services. The configuration data store 108 may replace or supplement a conventional backup and restore system that may be present on one or more of the devices 102, 104, and 106.

In some cases, the configuration data store 108 may replace a backup and restore system that operates on the various devices. In such a configuration, all of the data that may be used to restore, rebuild, or reconfigure a device may be stored by the configuration data store 108. The configuration data store 108 may organize the configuration data from the various devices and services into restore points.

A restore point may be a configuration for a point of time that an administrator may wish to restore. In many cases, a restore point may be created prior to making a change to one of the systems. For example, when a new service is installed or an upgrade is performed on one or more services, a restore point may be created prior to the installation in the event that a problem with the new installation, the systems may be restored to their previous operable condition.

The configuration data store 108 may have a single user interface through which an administrator may be able to select a restore point. Individual configuration sets comprising configuration data may be created for each device. The configuration sets may contain the configuration information for each service on the device.

The configuration data store 108 may be used for any type of configuration information for the devices 102, 104, and 108. Such information may include configuration information for each service operable on the device as well as operating system information, network connectivity settings, various application configuration settings, and any other data that may be used to recreate or restore one or more of the devices.

The configuration data store 108 may enable a backup or restore operation using various technologies or techniques. These techniques may include storing configuration data alone, storing configuration data with a file based backup, and storing configuration data with an image based backup.

In one embodiment, the configuration data store 108 may keep configuration data that may be used by a device to set various parameters and settings for various services or applications. When such an embodiment is used to restore or recreate one of the devices, an administrator may use a set of installation media to install an operating system, services, applications, or other data on a particular device. The configuration data store 108 may supply a configuration set that may be used by the device to configure the various software components to operate properly. During installation routines or after installation, the configuration set may be applied, enabling the device to operate as configured when a restore point was defined.

In another embodiment, the configuration data store 108 may keep configuration data in addition to a file-based backup of each device. The configuration data store 108 may be able to recreate a device by restoring each file on the device and applying a configuration set to ensure that the device operates properly. In some cases, such a system may track and store configuration changes separately from changes made to individual files within a file system. For example, the configuration data store 108 may perform a nightly backup of each device, but changes made to services, applications, or the operating system on a device may be tracked as the changes occur. Such tracking may enable multiple configuration restore points throughout a day as an administrator installs services, removes services, or makes changes to services or other settings.

In a third embodiment, the configuration data store 108 may store and track configuration data in addition to an image-based backup of each device. An image-based backup system may create backup copies of blocks of data from a device without regard to a file system or the contents of a file. Image-based backup systems often enable an exact recreation of a storage device without using operating system level functions to write the restored data, as in a file-based backup. As with the file-based embodiment above, an image-based embodiment may provide a mechanism for tracking configuration changes separately from the image-based backup. This may enable an administrator to define a restore point, perform an installation or other change to a service, and restore the system to a previous restore point without having to resort to restoring the entire image.

The configuration data store 108 may be used for various functions, including restoring one or more devices to a restore point, replacement or complete restoration of a device, migrating a device from one hardware platform to another, as well as initial configuration of multiple devices.

When the configuration data store 108 is used in a mode to restore multiple devices to a restore point, configuration sets that are unique to each device may be created and sent to the devices. Applications on the devices may receive a configuration set and make appropriate changes based on the configuration sets. In some cases, a configuration set may include every tracked configuration item for the device. In other cases, a configuration set may include only those items that may be changed to set the device to the proper restore point. For example, if the difference between the current setting and a restore point is the configuration of a single service, the configuration data store 108 may create a configuration set that contains the settings for the single service and transfer the configuration set to the device.

The configuration data store 108 may provide a set of configuration data that may be used in several different manners. In one embodiment, a device may have a configuration monitoring system that may receive a configuration set and inject the settings into the affected services, operating system functions, applications, or other functions. In some embodiments, the individual services, applications, operating system functions and other functions may detect the presence of a configuration set and make changes based on the contents of the configuration set. Such detection and change operations may be performed when a service is initially started or restarted, or when a configuration operation is executed within the service.

In some embodiments, the configuration data store 108 may make changes directly on the various devices. For example, the configuration data store 108 may have access to a file system on device 102 and may be capable of updating a configuration file directly on the file system. The configuration file may be used by a service to perform in a specific manner, and the configuration may be updated or changed directly by the configuration data store 108.

The configuration data store 108 may be used for initial installation and configuration of multiple devices, including the initial configuration of each device in a multiple server environment. In such a use, the configuration data store 108 may contain an initial configuration set for each of the various devices in a multiple server environment. When each server comes on line initially, the servers may connect to the configuration data store 108, determine a particular role for the server, and receive a configuration set. As each server begins installation and configuration using the configuration set, some services on one server may be dependent on services of another server. When such a situation occurs, the first server may pause installation and configuration until the service on the second server is operational.

In some uses, the configuration data store 108 may be used to migrate one device from a first hardware platform to another hardware platform. In such a use, a new hardware platform may be started with a basic operating system, connect to the configuration data store 108, and receive a configuration set that may be used to recreate the device to the same functions as the previous hardware platform. A similar scenario may be used when major hardware components are modified or changed, such as when a storage device crashes and a new one installed.

In some embodiments, the configuration data store 108 may create a configuration set that may contain a specialized set of configuration settings tailored for the particular device. In other embodiments, the configuration data store 108 may create a configuration set that may be used by multiple devices based on the role each device may perform. For example, a configuration set may be created that defines configuration settings for a mail server and a file server, each being a separate device. The same configuration set may be received by each server, and each server may use the settings from the configuration set that may apply to the particular role each server may perform.

The configuration data store 108 may be used in any type of multiple device environment. For example, a multiple server environment may be used where a configuration data store 108 may be used to centrally administer configuration restore points over many servers. In such an environment, a single service may have cascading effects across other services, servers, and client devices. By capturing and managing the configuration and restore points of multiple servers in a single configuration data store 108, the multiple servers may be managed more as a single unit than as many separate but interrelated devices.

In other environments, the various devices 102,104, and 106 may be servers, clients, network appliances, network routing and connection devices, network enabled instruments, remote sensing or output devices, or any other types of devices. Such devices may be connected by wired or wireless networks of any type, including network connections that use a combination of wired and wireless connections.

The various configuration data that are stored and managed by the configuration data store 108 may be collected or provided by any mechanism. In some cases, a centralized management console may be used to make changes to any of the various devices. Such a management console may implement a change and transmit the change information to the configuration data store 108.

In other cases, a service or device may be updated or changed individually. In such a case, some applications, services, or functions may be adapted to connect to the configuration data store 108 and forward the changes to the configuration data store 108.

In still other cases, a monitoring system 118 may monitor one or more devices. The monitoring system 118 may detect that a change has been made, determine the scope of the change and parameters relating to the change, and forward information to the configuration data store 108.

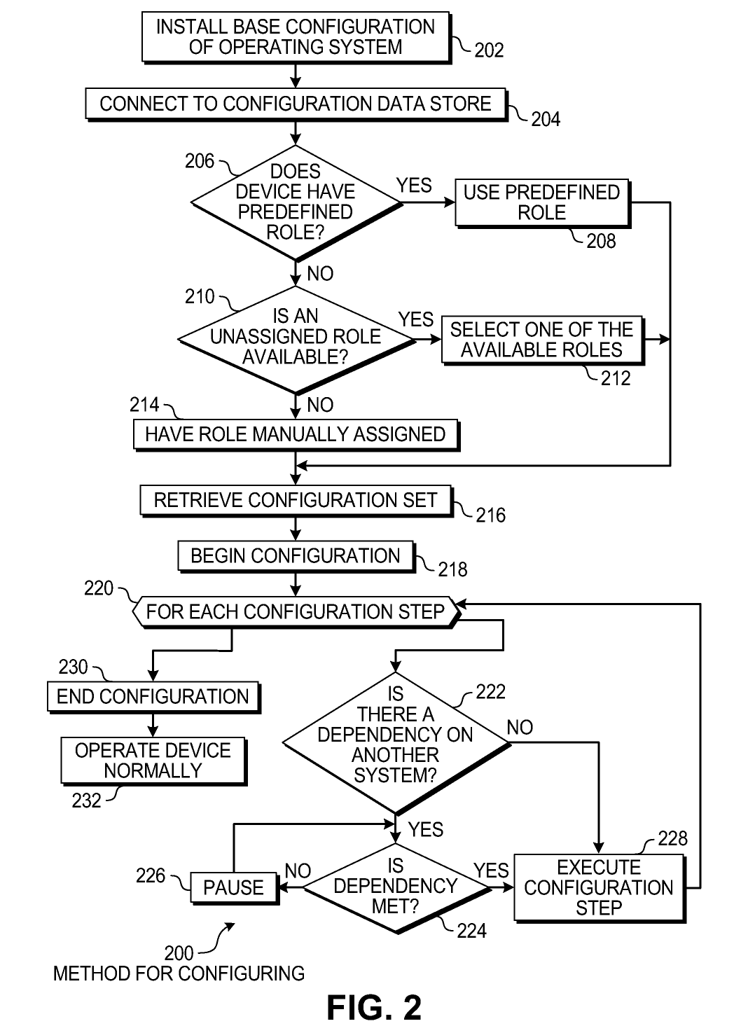

FIG. 2 is a flowchart illustration of an embodiment 200 showing a method for configuring a device. Embodiment 200 is one method by which a device may be configured using a configuration data store. Other embodiments may use different steps, nomenclature, or sequences to perform the functions described in embodiment 200. In some cases, additional steps or functions may be provided, while in other cases some steps or functions may be removed.

Embodiment 200 is a method by which a fresh installation of a device may be performed. The device may be, for example, a server in a multiple server environment.

A base configuration of an operating system may be installed and started in block 202. In some cases, the base configuration may be a specialized installation environment or may be the normal operating system that may be used by the device.

A connection to the configuration data store may be made in block 204. If the device has a predefined role in block 206, the predefined role may be used in block 208. If no predefined role exists in block 206 and an unassigned role is available in block 210, one of the available roles is selected in block 212, otherwise a role may be selected manually in block 214.

In a multiple device environment, such as a multiple server environment, each device may perform a particular role. The role may have a set of services, applications, or other functions that are specific to the device. For example, a multiple server environment may have one server as a mail server that performs many messaging functions. The server may also host mailboxes and contain storage for mail. Another server may host a website and contain various services that enable communication with web browsers.

In many cases, a configuration data store may be used in situations where roles for several devices may be predefined. An initial configuration of the environment may have, for example, three or four server devices each performing specific, predefined roles. In some cases, a device may have a predefined role. In the multiple server environment, one of the servers may have a large data storage device and may be designated to take a file server role. Another server may have specialized network connectivity hardware and may take a web server role. In such an example, the various servers may have a role determined based on the hardware configuration of each server.

In some cases, a device may connect to a configuration data store and may have a role assigned to the device. In such cases, the hardware or software characteristics of the device may be analyzed to determine what hardware or software exists on the device. Based on the specific hardware or software characteristics, an appropriate role may be automatically or manually selected.

In some such cases, several devices may be initially configured and connected to a configuration data store. After each of the devices is connected and analyzed, the configuration data store may be able to determine which role is appropriate for each device. In some embodiments, role assignments may be determined after every device is connected and analyzed. In other embodiments, a role assignment may be made initially, but may be reassigned when other devices are connected and analyzed.

When a role is assigned to a device, the role may be stored in the central configuration data store so that other devices may not be assigned the same role and so that other devices may be aware of the role for the device. In many embodiments, the role assignments to various devices may be enforced using rules. For example, some rules may define that one role may be performed by only one device. Other rules may define a role based on the configuration of other devices. For example, a rule may define a mail server role based on the configuration of a data storage role performed by another device. Such a rule may define a mail server role that uses the data storage of another server for mailbox data, for example.

After determining a role, the device may retrieve a configuration set in block 216. The configuration set may be retrieved by any mechanism. In some cases, a device may pull or download a configuration set from a configuration data store, while in other cases, the configuration data store may push a configuration set to the device. Some embodiments may have other methods for transferring a configuration set.

The configuration set may contain any information that may be used for installing, configuring, adjusting, modifying, or otherwise setting various services on a device to operate in a specific way. In some cases, a portion of the configuration set may be used by an installation application to configure an application or service in a particular manner. In other cases, a portion of the configuration set may be used by an application to inject configuration information in various locations within the device so that the device performs in a specific manner. Such an example may be registry settings or configuration files that may be used by operating system or application functions.

Configuration begins in block 218. In many embodiments, the configuration of a device may be defined by an application, script, or other data source that has predefined steps. Some embodiments may perform a configuration that includes configuring an operating system as well as applications and services. Other embodiments may have an operating system installed and configured in block 202 and use the configuration beginning in block 218 to configure various applications and services that operate within the operating system.

For each configuration step in block 220, if there is a dependency on another system in block 222, and the dependency is not met in block 224, the configuration may pause in block 226 until the dependency is met in block 224. If no such dependency exists in block 222 or if the dependency is met in block 224, the configuration step may be executed in block 228. In some embodiments, the dependency may be determined in block 224 by polling or querying the service or condition on which the configuration step depends to determine if the dependency is met. In other embodiments, a messaging system may be configured to wait until a message is received from the dependent service or condition.

In some embodiments, a deadlock condition may exist when two different systems are each dependent on the other for a service or condition in order to continue. Some embodiments may include an analysis of a set of configurations that may identify potential deadlock conditions. Some such embodiments may prohibit or block configuration sequences that may result in a deadlock situation while other embodiments may modify the configuration sequences to prevent a deadlock from occurring.

After each configuration step is performed in block 220, the configuration ends in block 230 and normal operation may begin in block 232.

Embodiment 200 illustrates how a configuration step may be paused when the step is dependent on another service or device. When deploying multiple devices with various services, each device may have logic similar to blocks 222-228 that enable the devices to separately and independently install or configure concurrently yet pause or wait for a device or service on which it depends.

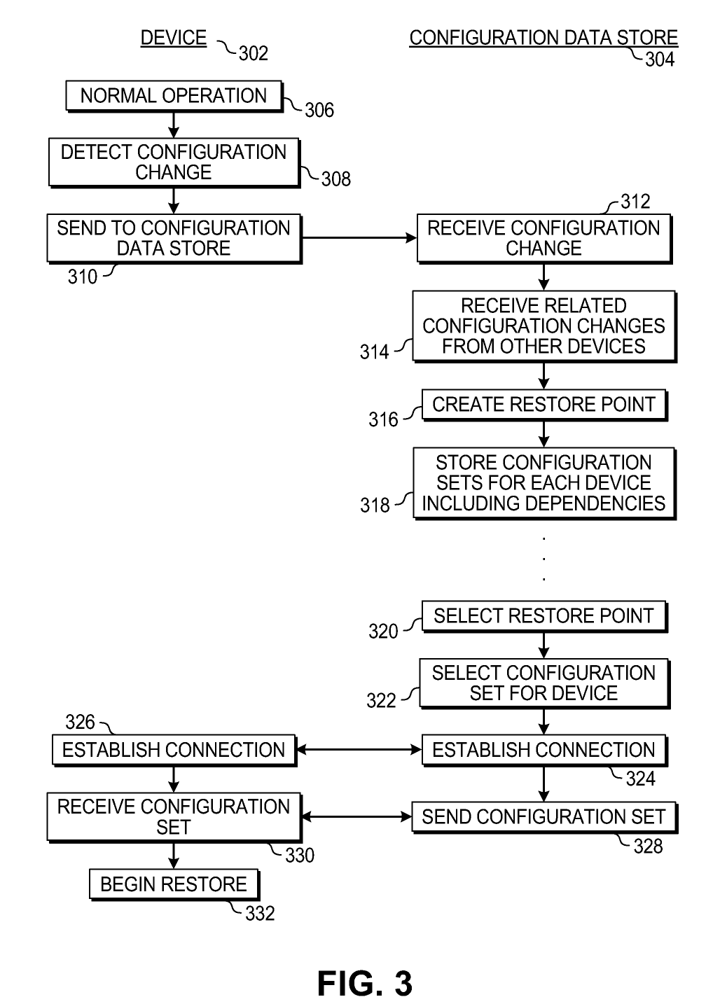

FIG. 3 is a timeline illustration of an embodiment 300 showing a sequence for storing configuration changes and for restoring a configuration to a restore point. Embodiment 300 is one example of a sequence that may be performed for storing configuration changes and restoring a configuration. Other embodiments may use different steps, nomenclature, or sequences to perform the functions described in embodiment 300. In some cases, additional steps or functions may be provided, while in other cases some steps or functions may be removed.

Embodiment 300 shows the functions of a device 302 on the left and a configuration data store 304 on the right.

Device 302 begins normal operation in block 306. Normal operation may be after the device 302 is fully configured and operational in its intended environment. For example, in a multiple server environment described previously, normal operation in block 306 may be when a server is fully configured and operating with other servers, each performing their respective functions.

A configuration change may be detected in block 308 through various mechanisms. In some cases, an application, control console, or other management function may be used to make configuration changes to services or functions. The management function may enable a user or administrator to input a desired change, then forward the change to the specific service or function that may be modified. In such an embodiment, the management function may send the configuration change to the configuration data store in block 310.

In another embodiment, a configuration change may be detected in block 308 by a monitoring agent that may periodically scan certain functions or services for any change. In still another embodiment, a service or function may be able to determine that a change is requested in block 308, perform the change, and forward data relating to the change to the configuration data store in block 310.

The configuration data store 304 may receive the configuration change in block 312 and any related changes from other devices in block 314. In some cases, an incoming change may indicate which devices, services, or functions may be affected by a specific change so that the configuration data store 304 may collect all affected configuration changes.

When the configuration is stabilized, a restore point may be defined in block 316 and configuration sets for each device may be stored, including dependencies in block 318.

Each embodiment may use different methods for storing the configuration information for restore points. In some cases, a configuration set may be created for each device that may be used directly by the device. In other cases, data may be stored from which individual configuration sets may be derived.

A restore operation may begin by selecting a restore point in block 320. A configuration set for the device 302 is selected in block 322. A connection is established between the device 302 and configuration data store 304 in blocks 324 and 326. The configuration set is transferred in block 328 and received in block 330.

After receiving the configuration set in block 330, the device 302 may being a restore operation in block 332.

In some embodiments, the various restore points may be examined or browsed to determine what changes may have occurred between restore points. In many embodiments, such an examination may be useful in debugging or in selecting an appropriate restore point. Such an examination may include displaying a delta view or change view that compares two restore points and displays the differences between the restore points.

In many embodiments, the restore points may include security services and security related applications for the various devices. The restore points may be configured so that various security features of a multiple device system are properly functioning and operational when the system is operating after the restore procedure is complete. In some embodiments, the security services may be separately configured and verified during a restore procedure to verify proper operation before the system is operational after restoration.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
installing a base operating system on a first device;
connecting to a configuration data store having configuration data for a plurality of devices, each of said plurality of devices having a role;
determining a role for said first device;
retrieving a first configuration set for said first device, said first configuration set matching said role and defining a configuration for a plurality of services operable on said first device; and
configuring said first device using said first configuration set.

2. The method of claim 1 further comprising:
determining a first restore point for said first device;
determining a first set of configuration parameters for said first restore point; and
storing said first set of configuration parameters in said configuration data store.

3. The method of claim 1, said plurality of devices having at least one dependency.

4. The method of claim 3, said configuring said first device comprising:
detecting said one dependency, said dependency comprising a first service operable on a second device;
detecting that said first service is not operable and pausing said configuring; and
detecting that said first service is operable and continuing said configuring.

5. The method of claim 1, said service comprising at least one of a group composed of:
an application;
a network service;
an operating system service; and
a service used by one or more other devices.

6. The method of claim 1, said first configuration set defining an initial configuration.

7. The method of claim 1, said first configuration set being a configuration set selected from a plurality of previous configuration sets.

8. The method of claim 1, said configuration store being a remotely hosted service.

9. The method of claim 1 further comprising:
making a change to said first device; and
storing said change in said configuration store.

10. The method of claim 9, said change being made through a configuration management tool adapted to configure a plurality of services.

11. The method of claim 9, said change being detected by analyzing a current configuration and comparing said current configuration to a previous configuration.

12. A computer readable medium comprising computer executable instructions adapted to perform the method of claim 1.

13. A system comprising:
a connection to a plurality of devices, each of said plurality of devices having a set of services, at least a first one of said devices having a first service that is dependent on a second service provided by a second device;
a central configuration store comprising configuration data for each of said plurality of devices;
a setup sequence operable on each of said plurality of devices and adapted to:
install a base operating system on a device;
connect to said configuration data store;
determine a role for said device;
retrieve a first configuration set for said device, said first configuration set matching said role and defining a configuration for a plurality of services operable on said device; and
configure said device using said first configuration set.

14. The system of claim 13, said system being adapted to:
receive a configuration update from each of said plurality of devices.

15. The system of claim 14, said system being further adapted to:
define a plurality of restore points;
select one of said plurality of restore points; and
for each of said plurality of devices, define a configuration set corresponding to said one of said plurality of restore points.

16. The system of claim 13, said central configuration store having a remote backup.

17. A method comprising:
making a configuration change to a first service on a first device, said first service being dependent on a second service provided on a second device;
storing said configuration change in a central configuration data store;
storing a dependency for said first service and said second service in said central configuration data store having a list of previous configuration changes;
selecting one of said previous configuration changes;
receiving a configuration set from said central configuration data store corresponding to said one of said previous configuration changes and said first device; and
configuring said first device using said configuration set.

18. The method of claim 17 further comprising:
detecting that said configuration change was made.

19. The method of claim 17, said configuring comprising:
determining that said second service is not available and pausing said configuring; and
determining that said second service is available and continuing said configuring.

20. A computer readable medium comprising computer executable instructions adapted to perform the method of claim 17.
